(19) United States
(12) Patent Application Publication
(10) Pub. No.: US 2015/0246504 A1
(43) Pub. Date: Sep. 3, 2015

(54) LAMINATED CARD WITH FLAT PROFILE

(71) Applicant: 3M INNOVATIVE PROPERTIES COMPANY, Saint Paul, MN (US)

(72) Inventors: Yufeng Liu, Woodbury, MN (US); Jose R. Escabi, Baldwin, WI (US); Daniel M. Czuprynski, Hudson, WI (US); Richard J. Thompson, Lino Lakes, MN (US)

(73) Assignee: 3M INNOVATIVE PROPERTIES COMPANY, Saint Paul, MN (US)

(21) Appl. No.: 14/440,228

(22) PCT Filed: Oct. 31, 2013
(86) PCT No.: PCT/US2013/067833

§ 371 Date: May 1, 2015

Related U.S. Application Data
(60) Provisional application No. 61/721,716, filed on Nov. 2, 2012.

(51) Int. Cl. B32B 7/00; B32B 27/30; B42D 25/00; B32B 7/12; B32B 27/08; B32B 27/20; B32B 27/36; B32B 27/40

(52) U.S. Cl. CPC B32B 7/005; B32B 27/36; B32B 27/304; B32B 27/40; B32B 27/365; B32B 7/12; B32B 27/08; B32B 27/20; B42D 25/00; B32B 2425/00; B32B 2307/514; B32B 2307/704; B32B 2307/41

(57) ABSTRACT

A multilayer card is provided having asymmetrically stretched polyester layer(s) and method of making the same are provided. Multilayer cards having asymmetrically stretched polyester layers can exhibit improved ability to pass a card warpage test as measured according to ISO/IEC 10373-1:2006(E) and ISO/IEC 7810:2003(E), relative to multilayer cards having symmetrically stretched polyester layers. A method of making the multilayer cards having asymmetrically stretched polyester layers can eliminate the need to observe a lane registration convention during manufacture of the multilayer cards.

### TECHNICAL FIELD

The disclosure relates generally to a polyester-containing card of flat profile made through lamination, and more particularly to a process for making curl-resistant polyester-containing cards.

### BACKGROUND

A typical process for producing polyester-containing cards includes cutting a symmetrically stretched polyester film into lanes, and then carefully matching the polyester film lanes for a lamination step in order to offset strain energies in the symmetrically stretched polyester film, and minimize undesirable curling or wrinkling in the resulting laminate. The required lane-matching process introduces several disadvantages, including increased cost and lower yield during manufacturing when errors in lane-matching occur, and manufacturers may also need to maintain and track an inventory of the polyester films identified by lane, resulting in undesirable cash flow and occupation of warehouse storage space.

### SUMMARY

We have discovered that by asymmetrically stretching a polyester film and then converting the asymmetrically stretched polyester film into sheets for the production of laminated polyester-containing cards, the requirement for lane matching can be eliminated and the resulting laminates exhibit good curl resistance. The ability to randomly select the converted sheets for lamination can greatly simplify manufacturing processes and help to reduce manufacturing costs and inventory requirements.

In a first aspect, the disclosure provides a method of making a multilayer card, the method including: forming a web from a polyester material; stretching the web in a first direction by a first stretch amount of 1.02 to 2.0 times an unstretched first dimension, and stretching the web in a second direction perpendicular to the first direction by a second stretch amount of 3.0 to 7.0 times an unstretched second dimension, to provide an asymmetrically stretched film. The asymmetrically stretched film is then converted into a plurality of asymmetrically stretched polyester sheets, followed by randomly selecting a first asymmetrically stretched polyester sheet and a second asymmetrically stretched polyester sheet from the plurality of asymmetrically stretched polyester sheets, and forming a multilayer stack. The multilayer stack includes: a core support layer, first and second cover layers disposed on opposite major surfaces of the multilayer stack, the first asymmetrically stretched polyester sheet disposed between the core support layer and first cover layer, and the second asymmetrically stretched polyester sheet disposed between the core support layer and the second cover layer. The first and second asymmetrically stretched polyester sheets are aligned with respect to the first direction. The multilayer stack is then laminated to form a laminated multilayer stack. A portion of the laminated multilayer stack is converted to form at least one multilayer card.

In a second aspect, the disclosure provides a multilayer card that includes first and second cover layers disposed on opposite major surfaces of the multilayer card, and a core support layer disposed between the first and second cover layers. A first asymmetrically stretched polyester layer is disposed between the first cover layer and the core support layer, and a second asymmetrically stretched polyester layer is disposed between the second cover layer and the core support layer. The multilayer card also includes a first ink-receptive layer disposed between the first cover layer and the first asymmetrically stretched polyester layer, and a second ink-receptive layer disposed between the second cover layer and the second asymmetrically stretched polyester layer. The multilayer card further includes a first adhesive layer disposed between the first asymmetrically stretched polyester layer and the core support layer, and a second adhesive layer disposed between the second asymmetrically stretched polyester layer and the core support layer. The first and second asymmetrically stretched polyester layers have each been stretched in a first direction by a first stretch of 1.02 to 2.0 times an unstretched first dimension, and also stretched in a second direction perpendicular to the first direction by a second amount of 3.0 to 7.0 times an unstretched second dimension. The first and second asymmetrically stretched polyester layers are aligned with respect to the first direction.

In a third aspect, the disclosure provides a multilayer card that includes first and second cover layers disposed on opposite major surfaces of the multilayer card, and an asymmetrically stretched polyester core layer disposed between the first and second cover layers. The multilayer card of the third aspect also includes a first ink-receptive layer disposed between the first cover layer and the asymmetrically stretched polyester core layer, and a second ink-receptive layer disposed between the second cover layer and the asymmetrically stretched polyester core layer. The multilayer card of the third aspect further includes a first adhesive layer disposed between the first ink-receptive layer and the asymmetrically stretched polyester core layer, and a second adhesive layer disposed between the second ink-receptive layer and the asymmetrically stretched polyester core layer. The asymmetrically stretched polyester core layer has been stretched in a first direction by a first stretch of 1.02 to 2.0 times an unstretched first dimension, and has also been stretched in a second direction perpendicular to the first direction by a second amount of 3.0 to 7.0 times an unstretched second dimension.

In a fourth aspect, the disclosure provides a composite article that includes an asymmetrically stretched polyester layer, an ink-receptive layer disposed on a first major surface of the asymmetrically stretched polyester layer, and an adhesive layer disposed on a second major surface of the asymmetrically stretched polyester layer. The asymmetrically stretched polyester core layer has been stretched in a first direction by a first stretch of 1.02 to 2.0 times an unstretched first dimension, and has also been stretched in a second direction perpendicular to the first direction by a second amount of 3.0 to 7.0 times an unstretched second dimension.

The terms “comprises” and variations thereof do not have a limiting meaning where these terms appear in the description and claims.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.”

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 7 includes 1, 1.05, 1.1, 1.2, 1.5, 2, 2.75, 3, 3.2, 3.5, 3.80, 4, 5, 6, 7, etc.).

The above summary of various aspects of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF DRAWINGS

FIG. 1 is a cross-sectional view of an exemplary embodiment of a multilayer card of the present disclosure.

FIG. 2 is a cross-sectional view of an exemplary embodiment of a multilayer card of the present disclosure.

FIG. 3 is a cross-sectional view of an exemplary embodiment of a multilayer card of the present disclosure.

FIG. 4 is a cross-sectional view of an exemplary embodiment of a composite article of the present disclosure.

FIGS. 5A and 5B are major surface views of an asymmetrically stretched web before and after conversion to a plurality of asymmetrically stretched polyester sheets of the present disclosure, respectively.

### DETAILED DESCRIPTION

Web planarity problems such as web curl are usually orthotropic, multilayer and two dimensional in nature. An “orthotropic” property refers to the difference in material properties between machine direction (MD) and transverse direction (TD) of web materials. This orthotropic nature of webs can result from different web processes such as tentering, lengthwise orientation, and film forming processes such as extrusion casting. A web curl problem can also manifest in a multilayer construction since most web based products go through processes such as coating/deposition and lamination under heat and pressure.

In the manufacture of laminated multilayer ID or transaction cards, care needs to be taken to avoid curling resulting from lamination. It is not unusual to include paired layers of a polyester film (e.g., a polyethylene terephthalate film) that have been biaxially stretched in a nearly symmetrical manner. However, it has been observed that unless a conventional lane registration approach is followed, the lamination of multilayer cards that include layers of nearly symmetrically biaxially stretched polyester can result in laminated cards that exhibit curl to an extent that they fail to pass ISO card warpage standards. As used herein, “conventional lane registration approach” means that the width of the web is divided into multiple lanes and that films used in card construction are taken in pairs from lanes that are on opposite sides and equidistant from the centerline of the web.

It has now been surprisingly found that by randomly pairing sheets of certain asymmetrically stretched polyester films, laminated multilayer cards can be produced that pass ISO card warpage standards. By including a random selection of the asymmetrically stretched polyester sheets, methods of the present disclosure do not require a conventional lane registration approach.

In some embodiments, the present disclosure includes a laminated multilayer card that includes randomly paired layers of asymmetrically stretched polyester film disposed on opposite sides of a core support layer. The asymmetrically stretched polyester film is a polyester film that is stretched in a first direction by a first stretch of 1.02 to 2.0 times an unstretched first dimension, and is also stretched in a second direction perpendicular to the first direction by a second amount of 3.0 to 7.0 times an unstretched second dimension.

In the course of the present work, it was discovered that when a polyester film was stretched asymmetrically, the resulting film had unexpected properties that resulted in a laminated card having a flat profile, without needing to observe a special lane registration protocol for the assembly of a multilayer stack. When the cast web was stretched in the first direction between about 1.02 to 2.0, the film remained flat enough and be useful in making into a card. However, when the cast web was stretched in the first direction between about 2.0 and 3.0, the film became non-uniform in appearance in the stretching direction and therefore was not useful for laminating into a card. When the cast web was stretched in the first direction beyond about 3.0, the film was usually flat but not useful for providing flat cards without observing a special lane registration protocol.

The randomly paired layers of asymmetrically stretched polyester film are obtained by forming a web from a polyester material, stretching the web in the first and second directions to obtain an asymmetrically stretched web, and then converting the asymmetrically stretched web into a plurality of asymmetrically stretched polyester sheets. A pair of the asymmetrically stretched polyester sheets is then randomly selected from the plurality of asymmetrically stretched polyester sheets for inclusion in a laminated multilayer card of the present disclosure. The randomly paired layers of asymmetrically stretched polyester film are aligned with each other with respect to the first direction of the stretching. The laminated multilayer card so obtained can pass card warpage (i.e., “curl”) testing according to ISO/IEC 10373-1:2006(E), Section 5.1 “Card warpage”, evaluating the card warpage test results according to ISO/IEC 7810:2003(E), Section 8.11 “Overall card warpage”.

A laminated multilayer card (i.e., “multilayer card”) of the present disclosure includes several types of layers laminated together to give a multilayer card having an overall thickness of preferably at least about 250 micrometers, more preferably at least 510 micrometers, even more preferably at least 635 micrometers. In some embodiments, the multilayer card has a thickness of preferably up to about 1270 micrometers, more preferably up to 1020 micrometers, even more preferably up to 890 micrometers. In some embodiments, the multilayer card has a thickness preferably in a range from about 250 micrometers to about 1270 micrometers, more preferably in a range from 510 micrometers to 1020 micrometers, even more preferably in a range from 635 micrometers to 890 micrometers, and most preferably in a range from 680 micrometers to 840 micrometers.

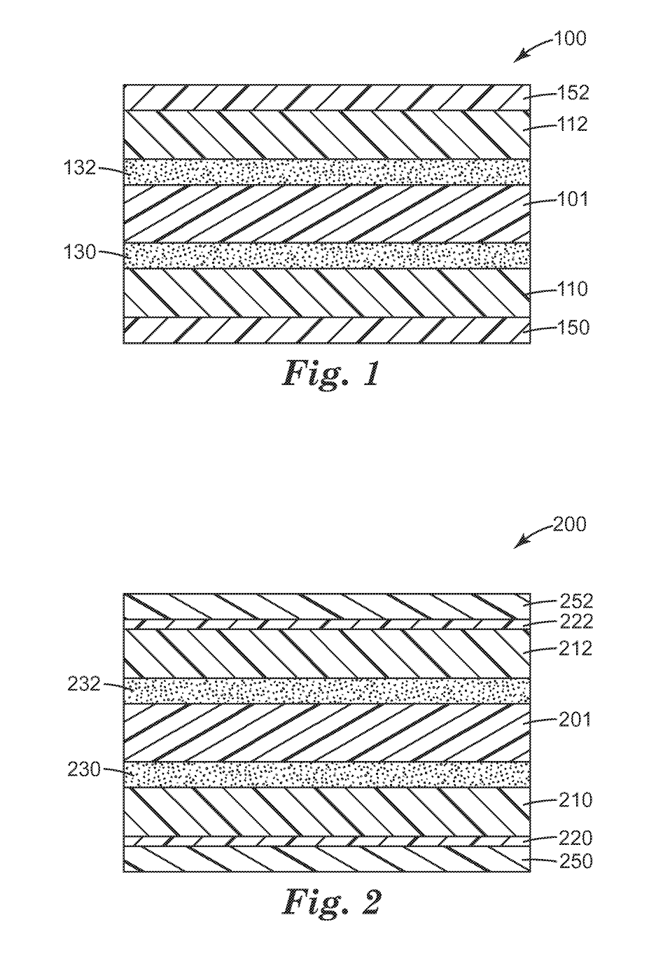

FIG. 1 shows a cross-sectional view of an exemplary embodiment of a multilayer card 100 that includes a core support layer 101 and first and second cover layers 150 and 152 disposed at opposite surfaces of multilayer card 100. A first asymmetrically stretched polyester layer 110 is disposed between core support layer 101 and first cover layer 150, and a second asymmetrically stretched polyester layer 112 is disposed between core support layer 101 and second cover layer 152. Also shown in FIG. 1 are first and second adhesive layers 130 and 132, disposed between core layer 101 and first and second asymmetrically stretched polyester layers 110 and 112, respectively.

The asymmetrically stretched polyester layers of the present disclosure can be films of any suitable polyester described herein, e.g., polyethylene terephthalate (“PET”), polyethylene naphthalate (“PEN”), polybutylene terephthalate (“PBT”), copolymers and blends that incorporating terephthalate and/or naphthalate chemical units, or any other suitable polyester material. In some preferred embodiments, the polyester material is PET. In particularly preferred embodiments, the polyester material is semi-crystalline PET.

In some embodiments, an asymmetrically stretched polyester layer of the present disclosure is opaque. The opaqueness can be realized by blending in the resin with microparticles or nanoparticles selected from TiO₂, BaSO₄, voids, CaCO₃, talc, or any combination thereof to achieve desirable level of opaqueness. The desired opaqueness can be measured by visible light transmission (“VLT”) through the film and it is preferred that VLT be less than 50%, more preferably less than 20%, and most preferably less than 10%. As used herein, “visible light” refers to light having a wavelength between about 390 nm and 750 nm. VLT can be measured according to ASTM D1003-61 using a haze measuring device (e.g., that haze measuring device available from BYK Gardner, Inc., Silver Spring, Md., under the trade designation “HAZEGARD PLUS”, BYK Gardner catalog number 4725).

In some embodiments, an asymmetrically stretched polyester layer of the present disclosure is of a specific color. This can be realized by blending in proper amount of colored pigments selected from red, green, blue, black, white, pink, yellow or combination thereof.

In some embodiments, an asymmetrically stretched polyester layer of the present disclosure is transparent. The desired transparency can be measured by visible VLT through the film and it is preferred that VLT be more than 70%, more preferably more than 80%, and most preferably more than 90%.

The asymmetrically stretched polyester layers of the present disclosure can be prepared by known techniques (e.g., see U.S. Published Patent Application No. 2011/0103036 (Bosl et al.)). For example, a polyester resin can be extruded to produce a polyester web. The polyester web can then be stretched in a first direction, and then in a second direction that is orthogonal to the first direction, to produce an asymmetrically stretched polyester web. The stretching of the polyester web in the first direction can be done before, after, or simultaneously with the stretching in the second direction. The polyester web can be heated during the stretching, typically at a temperature in a range from 70° C. to 125° C., and then is typically heat set at a temperature in a range from 150° C. to 250° C. (see, e.g., GB-A-838708). The heating for the first and second stretches can be the same as or different from each other (when those stretches are done separately). The asymmetrically stretched polyester web so produced can then be converted into a plurality of asymmetrically stretched polyester sheets, by any conventional slitting or cutting process. Some examples of sheet sizes useful for the production of multilayer cards of the present disclosure can include about 30 cm by about 30 cm, about 45 cm by about 61 cm, about 51 cm by about 64 cm, about 61 cm by about 71 cm, or any other suitable sheet sizes.

In some embodiments, asymmetrically stretched polyester layers 110, 112 for multilayer card 100 have a thickness of preferably at least 50 micrometers, more preferably at least 100 micrometers. In some embodiments, asymmetrically stretched polyester layers for multilayer card 100 preferably have a thickness of up to 510 micrometers, more preferably up to 355 micrometers. In some embodiments, asymmetrically stretched polyester layers for multilayer card 100 preferably have a thickness in a range from 50 micrometers to 510 micrometers, more preferably from 100 micrometers to 355 micrometers.

The multilayer card 100 shown in FIG. 1 includes core support layer 101. The core support layer can be made of any suitable material. In some embodiments, the core support layer is made of a polymeric material selected from the group consisting of PET, PEN, polyvinyl chloride (“PVC”), polycarbonate (“PC”), poly(methyl methacrylate) (“PMMA”), copolymers thereof, and blends thereof. In other embodiments, the core support layer is made of primarily metal or metal alloy such as steel, stainless steel, cupper, titanium, gold, silver, or alloy thereof. In some embodiments, core support layer can include an antenna, or a chip (e.g., an RFID chip) with an antenna.

In some embodiments, the core support layer 101 has a thickness of preferably at least 125 micrometers, more preferably at least 200 micrometers. In some embodiments, the core support layer preferably has a thickness of up to 510 micrometers, more preferably up to 355 micrometers. In some embodiments, the core support layer has a thickness preferably in a range from 125 micrometers to 510 micrometers, more preferably from 200 micrometers to 355 micrometers.

The multilayer card 100 shown in FIG. 1 includes first and second cover layers 150 and 152. In some embodiments, the cover layer is made of a polymeric material selected from the group consisting of PET, PEN, PVC, PC, PMMA, copolymers thereof, and blends thereof. The cover layer can include an adhesion promoting layer on a major surface thereof to further enhance adhesion between the cover layer and an adjacent layer. A commercially available cover layer can include, for example, the 2 mil PVC adhesive overlay film available from Klockner Pentaplast of America, Inc., Gordonsville, Va. under the trade designation “PENTAPLAST SB6”. In some embodiments, the cover layers 150 and 152 can be a randomly selected pair of asymmetrically stretched polyester film layers.

In some embodiments, the cover layer has a thickness of preferably at least 25 micrometers. In some embodiments, the core support layer has a thickness of preferably up to 255 micrometers, more preferably up to 100 micrometers. In some embodiments, the core support layer has a thickness preferably in a range from 25 micrometers to 255 micrometers, more preferably from 25 micrometers to 100 micrometers.

The multilayer card 100 shown in FIG. 1 includes first and second adhesive layers 130 and 132. The adhesive layer can be any suitable adhesive selected from the group consisting of pressure sensitive adhesives, thermally activated adhesives, hot melt adhesives, radiation cured adhesives, and combinations thereof.

In some embodiments, the adhesive layer is selected from acrylic, silicone, polyester, polyurethane, polyurea, acetate, or combination thereof. The thickness of the adhesive layer is preferably from 2.5 micrometers to 125 micrometers, or more preferably from 12 micrometers to 75 micrometers.

FIG. 2 shows a cross-sectional view of another exemplary embodiment of a multilayer card 200 of the present disclosure. The multilayer card 200 is similar to multilayer card 100, including core support layer 201, first and second asymmetrically stretched polyester layers 210 and 212, first and second adhesive layers 230 and 232, and first and second cover layer 250 and 252 (each corresponding to their “100-series” counterpart layers in multilayer card 100), with the addition of first ink-receptive layer 220 disposed between first cover layer 250 and first asymmetrically stretched polyester layer 210, and second ink-receptive layer 222 disposed between second cover layer 252 and second asymmetrically stretched polyester layer 212.

The ink-receptive layers 220 and 222 can be a suitable ink-receptive layer known for inclusion in multilayer ID and transaction cards (e.g., see U.S. Pat. No. 8,012,550 (Ylitalo et al.), the entire disclosure of which is incorporated herein by reference). In some embodiments, the ink-receptive layer includes a crosslinked polymer selected from the group consisting of polyurethanes, polyethers, polyesters, polyacrylics, polyureas, copolymers thereof, and blends thereof. In some embodiment, the ink-receptive layer is a polymeric film made from a resin material selected from the group consisting of PET, PEN, PVC, PC, polyurethane, polyacrylate, copolymers thereof, and blends thereof. An ink-receptive layer of the present disclosure can optionally function as an adhesion-promoting layer between two other layers (e.g., between asymmetrically stretched polyester layer 210 and cover layer 250) in instances where enhanced adhesion is desirable.

In some embodiments, the ink-receptive layer has a thickness of preferably at least 1 nanometer micrometers, more preferably at least 5 nanometers. In some embodiments, the ink-receptive layer has a thickness of preferably up to 50 micrometers, more preferably up to 125 micrometers. In some embodiments, the ink-receptive layer has a thickness preferably in a range from 1 nanometer to 125 micrometers, more preferably from 5 nanometers to 50 micrometers.

In some embodiments, the ink-receptive layer can be applied to a polyester web of the present disclosure before, during, or after the stretching steps. In some preferred embodiments, the ink-receptive layer is applied to the polyester web before the stretching process. In some other preferred embodiments, the ink-receptive layer was applied after the stretching process. The ink-receptive layer may be applied from an organic or aqueous solvent, to an already stretched polyester web, or more preferably before or during the stretching operation. Alternatively, the ink-receptive layer may be formed by casting a resin of ink-receptive material onto a preformed polyester web. Conveniently, however, formation of a composite sheet (for example, a polyester web and an ink-receptive layer) is achieved by co-extrusion, either by simultaneous co-extrusion of the respective resins as film-forming layers through independent orifices of a multi-orifice die, and thereafter uniting the still molten layers, or, preferably, by single-channel co-extrusion in which molten streams of the respective resins are first united within a channel leading to a die manifold, and thereafter extruded together from the die orifice under conditions of streamline flow without intermixing thereby to produce a multilayer composite sheet. The coextruded multilayer composite sheet includes the layer of the polyester material and a least one of an ink-receptive layer, an adhesive layer, a structural layer, or combinations thereof, disposed adjacent to the layer of polyester material.

A co-extruded sheet is then stretched to achieve molecular orientation of the substrate, and preferably the coextruded is subsequently heat-set. Generally, the conditions applied for stretching the polyester web layer will also induce partial crystallization of the ink-receptive layer and it is therefore preferred to heat set under dimensional restraint at a temperature selected to develop the desired morphology of the ink-receptive layer. In some embodiments, proper heat-setting is carried out at a temperature below the crystalline melting temperature of the ink-receptive resin material and permitting or causing the composite to cool, the ink-receptive layer will remain essentially crystalline. However, by heat-setting at a temperature greater than the crystalline melting temperature of the ink-receptive polyester, the latter will be rendered essentially amorphous. Heat-setting of a composite sheet comprising a polyester web and an ink-receptive layer is conveniently achieved at a temperature within a range of from 140° C. to 200° C. to yield a substantially crystalline ink-receptive layer, or from 200° C. to 250° C. to yield an essentially amorphous ink-receptive layer. An essentially amorphous ink-receptive layer is preferred.

In embodiments where the ink-receptive layer is coated onto the polyester web before or after stretching, a desired thickness for the ink-receptive layer can be in a range of from 1 to 50 nanometers. However, in other embodiments, where the ink-receptive layer is co-extruded with the polyester web, a desired target thickness for the ink-receptive layer (after stretching the co-extruded composite sheet) can be in a range from 2.5 micrometers to 125 micrometers.

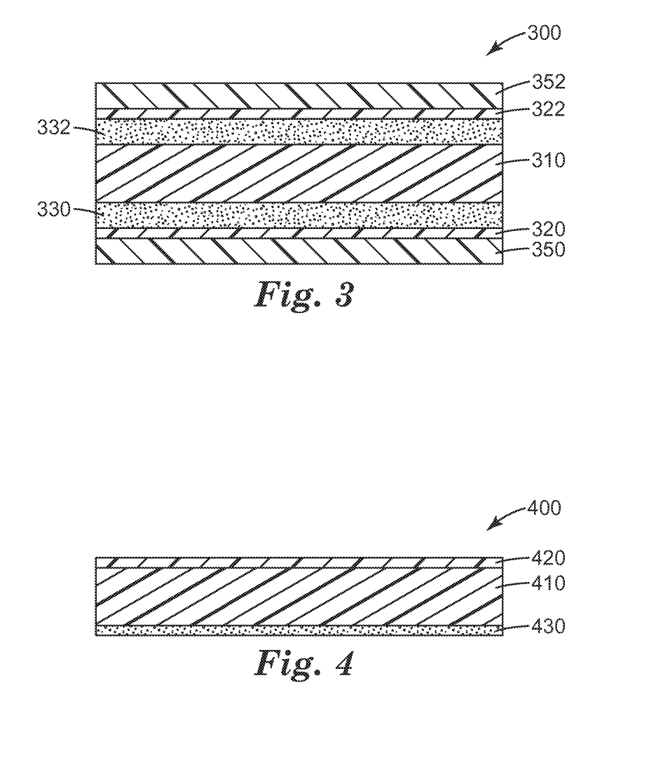

FIG. 3 shows a cross-sectional view of an exemplary embodiment of a multilayer card 300 of the present disclosure. Multilayer card 300 includes an asymmetrically stretched polyester core layer 310 disposed between first and second cover layers 350 and 352. A first ink-receptive layer 320 is disposed between first cover layer 350 and asymmetrically stretched polyester core layer 310, and a second ink-receptive layer 322 is disposed between second cover layer 352 and asymmetrically stretched polyester core layer 310. Also shown in FIG. 3 is a first adhesive layer 330 disposed between first ink-receptive layer 320 and asymmetrically stretched polyester core layer 310, and a second adhesive layer 332 disposed between second ink-receptive layer 322 and asymmetrically stretched polyester core layer 310. Each of the layers in multilayer card 300 can be of the same materials and properties as the corresponding “100-series” layers described for multilayer card 100, except that in some embodiments the thickness of asymmetrically stretched polyester core layer 310 is preferably in a range from 50 micrometers to 510 micrometers, more preferably from 150 micrometers to 410 micrometers, even more preferably from 230 micrometers to 330 micrometers.

While multilayer card 300 differs from multilayer cards 100 and 200 in that only a single asymmetrically stretched polyester layer is shown (i.e., asymmetrically stretched polyester core layer 310), it will be appreciated that cover layers 350 and 352 can also be selected to include a randomly selected pair of asymmetrically stretched polyester layers that are each stretched in a first direction by a first stretch of 1.02 to 2.0 times an unstretched first dimension and stretched in a second direction perpendicular to the first direction by a second amount of about 3.0 to 7.0 times an unstretched second dimension, and wherein the first and second asymmetrically stretched polyester layers (350, 352) are aligned with respect to the first direction. Such constructs can also have the enhanced resistance to curl relative to those corresponding constructs where symmetrically stretched polyester layers are used and where lane matching is a requirement.

In some embodiments of any of multilayer cards 100, 200, or 300, the cover layers can be adhered to their adjacent layers by the inclusion of an added layer of adhesive, using any suitable adhesive from among those described above.

FIG. 4 shows a cross-sectional view of a composite article 400 of the present disclosure, including asymmetrically stretched polyester layer 410, ink-receptive layer 420 disposed on a first major surface of asymmetrically stretched polyester layer 400, and an adhesive layer 430 disposed on a second major surface of asymmetrically stretched polyester layer 410. As with the asymmetrically stretched polyester layers in multilayer cards 100, 200, and 300, asymmetrically stretched polyester core layer 410 is stretched in a first direction by a first stretch of 1.02 to 2.0 times an unstretched first dimension and stretched in a second direction perpendicular to the first direction by a second amount of about 3.0 to 7.0 times an unstretched second dimension. The composition and thicknesses of asymmetrically stretched polyester layer 410, ink-receptive layer 420, and adhesive layer 430 can be selected to the same as any of the corresponding layers in the present disclosure. Composite article 400 can be made by coating ink-receptive layer 420 onto a major surface of a polyester web before, during or after the stretching step(s). The adhesive layer 430 is typically applied to asymmetrically stretched polyester layer 410 after it has been stretched. In some other embodiments, the adhesive layer 430 is applied to base polyester layer 410 during coextrusion and stretched asymmetrically afterwards.

It will be appreciated that composite articles analogous to composite article 400 can be constructed that include an asymmetrically stretched polyester layer 410 having an ink-receptive layer disposed on both major surfaces thereof, or, alternatively, an adhesive layer disposed on both major surfaces thereof.

It will be appreciated that composite article 400 and/or the composite articles analogous to composite article 400 can be usefully incorporated into multilayer laminate structures, including multilayer ID or transaction cards. For example, two sheets of composite article 400 can be adhered together via their respective adhesive layers 430 to form a multilayer composite article (not shown), having a pair of the two asymmetrically stretched polyester layers 410 disposed between their two respective ink-receptive layers 420.

In some embodiments, each of the layers in composite article 400 and the composite articles analogous to composite article 400 can have thicknesses selected according to the descriptions for the asymmetrically stretched polyester film layers, the adhesive layers, and the ink-receptive layers described for any of the multilayer cards 100, 200, or 300.

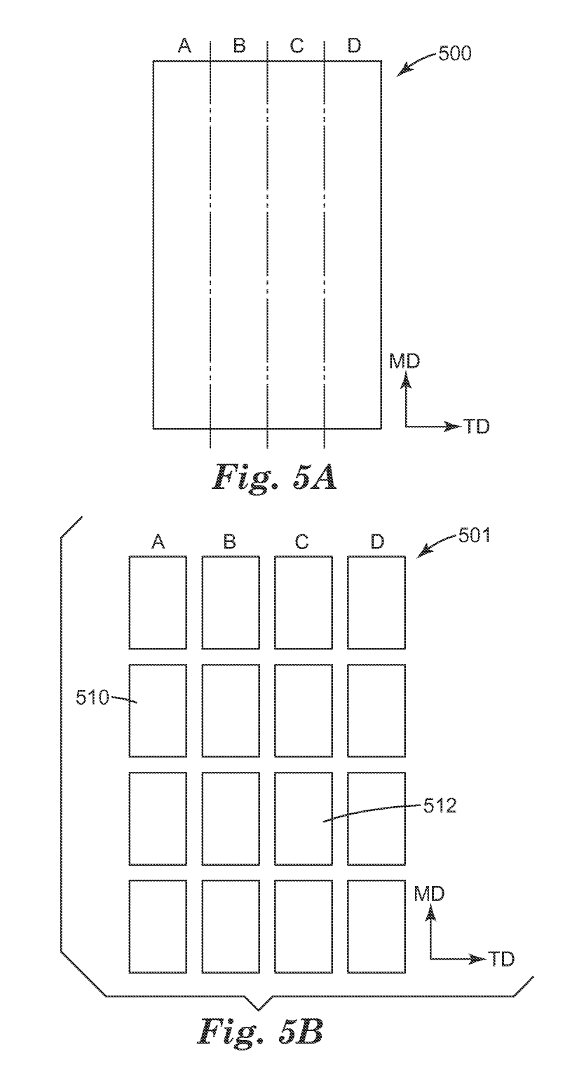

FIG. 5A shows a major surface view of an asymmetrically stretched polyester film 500, including an indication of a machine direction “MD” and a transverse direction “TD”. It will be understood that as used herein, a “first stretch direction” can refer to either MD or TD, although typically the first stretch direction will be the machine direction, for convenience. Phantom lines are included to indicate where asymmetrically stretched polyester film 500 can be cut to generate lanes A, B, C, and D. The number of lanes can be in a range from 2 to 12, more preferably in a range from 4 to 8. The lanes can all be the same width, or some of the lanes can be wider or narrower than others.

Individual asymmetrically stretched polyester sheets can be cut from any portion of asymmetrically stretched polyester film 500. FIG. 5B shows a plurality of asymmetrically stretched polyester sheets 501, including individual asymmetrically stretched polyester sheets 510 and 512. Lanes A, B, C, and D are labeled to indicate the lanes resulting from a conversion operation (e.g., slitting) performed on asymmetrically stretched polyester film 500 to create these lanes, shown as oriented in the machine direction. It can be seen that the conversion operation can also cut across the lanes in the transverse direction, to form plurality of asymmetrically stretched polyester sheets 501. While individual asymmetrically stretched polyester sheets (e.g., 510 and 512) are shown as being longer in the machine direction than in the transverse direction, this is not required, and any individual asymmetrically stretched polyester sheet can alternatively be longer in the machine direction than in the transverse direction, or can even have the same lengths in the machine direction and in the transverse direction

The multilayer card according to the present disclosure can include additional components, for example, a magnetic stripe and/or an electronic chip, either at the surface or encapsulated (e.g., in an epoxy material) inside the card.

### Embodiments

Embodiment 1. A method of making a multilayer card, the method comprising:
forming a web from a polyester material;
stretching the web in a first direction by a first stretch amount of 1.02 to 2.0 times an unstretched first dimension;
stretching the web in a second direction perpendicular to the first direction by a second stretch amount of 3.0 to 7.0 times an unstretched second dimension, to provide an asymmetrically stretched film;
converting the asymmetrically stretched film into a plurality of asymmetrically stretched polyester sheets;
randomly selecting a first asymmetrically stretched polyester sheet and a second asymmetrically stretched polyester sheet from the plurality of asymmetrically stretched polyester sheets;
forming a multilayer stack comprising a core support layer, first and second cover layers disposed on opposite major surfaces of the multilayer stack, the first asymmetrically stretched polyester sheet disposed between the core support layer and first cover layer, and the second asymmetrically stretched polyester sheet disposed between the core support layer and the second cover layer; wherein the first and second asymmetrically stretched polyester sheets are aligned with respect to the first direction;
laminating the multilayer stack to form a laminated multilayer stack; and
converting a portion of the laminated multilayer stack to form a multilayer card.

Embodiment 2. The method of embodiment 1, further comprising applying an ink-receptive layer on a first major surface of the web, and arranging the first and second asymmetrically stretched polyester sheets so that the multilayer stack comprises a first ink-receptive layer disposed between the first cover layer and the first asymmetrically stretched polyester sheet, and a second ink-receptive layer disposed between the second cover layer and the second asymmetrically stretched polyester sheet.

Embodiment 3. The method of embodiment 1, further comprising applying an adhesive layer on a second major surface of the web, and arranging the first and second asymmetrically stretched polyester sheets so that the multilayer stack comprises a first adhesive layer disposed between the first asymmetrically stretched polyester sheet and the core support layer, and a second adhesive layer disposed between the second asymmetrically stretched polyester sheet and the core support layer.

Embodiment 4. The method of any one of embodiments 1 to 3, further comprising applying an adhesive layer to each of the first and second major surfaces of the core support layer prior to laminating the multilayer stack.

Embodiment 5. The method of any one of embodiments 1 to 4, wherein a ratio of the second stretch amount to the first stretch amount is in a range from 1.5 to 7.

Embodiment 6. The method of any one of embodiments 1 to 5, wherein the first direction is a machine direction, and wherein the second direction is a transverse direction.

Embodiment 7. The method of any one of embodiments 1 to 6, wherein the polyester material is semi-crystalline polyethylene terephthalate.

Embodiment 8. The method of any one of embodiments 1 to 7, wherein each of the first and second asymmetrically stretched sheets is opaque.

Embodiment 9. The method of any one of embodiments 1 to 8, wherein forming the web from the polyester material further comprises forming a coextruded multilayer composite that comprises the layer of the polyester material and a least one of an ink-receptive layer, an adhesive layer, a structural layer, or combinations thereof, disposed adjacent to the layer of polyester material.

Embodiment 10. A multilayer card comprising:
first and second cover layers disposed on opposite major surfaces of the multilayer card;
a core support layer disposed between the first and second cover layers;
a first asymmetrically stretched polyester layer disposed between the first cover layer and the core support layer;
a second asymmetrically stretched polyester layer disposed between the second cover layer and the core support layer;
a first ink-receptive layer disposed between the first cover layer and the first asymmetrically stretched polyester layer;
a second ink-receptive layer disposed between the second cover layer and the second asymmetrically stretched polyester layer;
a first adhesive layer disposed between the first asymmetrically stretched polyester layer and the core support layer; and
a second adhesive layer disposed between the second asymmetrically stretched polyester layer and the core support layer;
wherein the first and second asymmetrically stretched polyester layers are each stretched in a first direction by a first stretch of 1.02 to 2.0 times an unstretched first dimension and stretched in a second direction perpendicular to the first direction by a second amount of 3.0 to 7.0 times an unstretched second dimension, and wherein the first and second asymmetrically stretched polyester layers are aligned with respect to the first direction.

Embodiment 11. The multilayer card of embodiment 10, wherein the polyester in the first and second asymmetrically stretched polyester layers is semi-crystalline polyethylene terephthalate. Embodiment 12. The multilayer card of embodiment 10 or embodiment 11, wherein the first and second cover layers each comprise a polymeric material selected from the group consisting of polyethylene terephthalate, polyethylene naphthalate, polyvinyl chloride, polycarbonate, poly(methyl methacrylate), copolymers thereof, and blends thereof, and has a thickness in a range from about 25 micrometers to about 250 micrometers.

Embodiment 13. The multilayer card of any one of embodiments 10 to 12, wherein the core support layer comprises a polymeric material selected from the group consisting of polyethylene terephthalate, polyethylene naphthalate, polyvinyl chloride, polycarbonate, poly(methyl methacrylate), copolymers thereof, and blends thereof, and has a thickness in a range from about 125 micrometers to about 510 micrometers.

Embodiment 14. The multilayer card of any one of embodiments 10 to 13, wherein the first and second ink-receptive layer each comprise a polymeric material selected from the group consisting of polyethylene terephthalate, polyethylene naphthalate, polyvinyl chloride, polycarbonate, polyurethane, polyacrylate, copolymers thereof, and blends thereof.

Embodiment 15. The multilayer card of any one of embodiments 10 to 14, wherein a ratio of the second stretch to the first stretch is in a range from 1.5 to 7.

Embodiment 16. The multilayer card of any one of embodiments 10 to 15, wherein the first and second asymmetrically stretched polyester layers are opaque.

Embodiment 17. The multilayer card of any one of embodiments 10 to 16, wherein the first and second asymmetrically stretched polyester layers further comprises at least one of a UV absorber, a color pigment, a plasticizer, and anti-plasticizer, or a combination thereof.

Embodiment 18. The multilayer card of any one of embodiments 10 to 17, wherein the adhesive layer comprises at least one of a pressure sensitive adhesive, a thermally activated adhesive, a hot melt adhesive, a radiation cured adhesive, or combinations thereof.

Embodiment 19. The multilayer card of any one of embodiments 10 to 18, wherein the first and second asymmetrically stretched polyester layers has a thickness in a range from about 50 micrometers to about 510 micrometers.

Embodiment 20. The multilayer card of any one of embodiments 10 to 19, wherein the multilayer card passes a CARD WARPAGE TEST as measured according to ISO/IEC 10373-1:2006(E) and ISO/IEC 7810:2003(E).

Embodiment 21. A multilayer card comprising:
first and second cover layers disposed on opposite major surfaces of the multilayer card;
an asymmetrically stretched polyester core layer disposed between the first and second cover layers;
a first ink-receptive layer disposed between the first cover layer and the asymmetrically stretched polyester core layer;
a second ink-receptive layer disposed between the second cover layer and the asymmetrically stretched polyester core layer;
a first adhesive layer disposed between the first ink-receptive layer and the asymmetrically stretched polyester core layer; and
a second adhesive layer disposed between the second ink-receptive layer and the asymmetrically stretched polyester core layer;
wherein the asymmetrically stretched polyester core layer is stretched in a first direction by a first stretch of 1.02 to 2.0 times an unstretched first dimension and stretched in a second direction perpendicular to the first direction by a second amount of 3.0 to 7.0 times an unstretched second dimension.

Embodiment 22. The multilayer card of embodiment 21, wherein the polyester in the asymmetrically stretched polyester core layer is selected from the group consisting of polyethylene terephthalate, polyethylene naphthalate, polybutylene terephthalate, copolymers thereof, and blends thereof.

Embodiment 23. The multilayer card of embodiment 21 or embodiment 22, wherein the first and second cover layers each comprise a polymeric material selected from the group consisting of polyethylene terephthalate, polyethylene naphthalate, polyvinyl chloride, polycarbonate, poly(methyl methacrylate), copolymers thereof, and blends thereof, and has a thickness in a range from about 25 micrometers to about 250 micrometers.

Embodiment 24. The multilayer card of any one of embodiments 21 to 23, wherein the polyester in the asymmetrically stretched polyester core layer is semi-crystalline polyethylene terephthalate.

Embodiment 25. The multilayer card of any one of embodiments 21 to 24, wherein the first and second ink-receptive layer each comprise a polymeric material selected from the group consisting of polyethylene terephthalate, polyethylene naphthalate, polyvinyl chloride, polycarbonate, polyurethane, polyacrylate, copolymers thereof, and blends thereof.

Embodiment 26. The multilayer card of any one of embodiments 21 to 25, wherein a ratio of the second stretch to the first stretch is in a range from about 1.5 to about 7.

Embodiment 27. The multilayer card of any one of embodiments 21 to 26, wherein the first and second asymmetrically stretched polyester layers are opaque.

Embodiment 28. The multilayer card of any one of embodiments 21 to 27, wherein the first and second asymmetrically stretched polyester layers further comprises at least one of a UV absorber, a color pigment, a plasticizer, and anti-plasticizer, or a combination thereof.

Embodiment 29. The multilayer card of any one of embodiments 21 to 28, wherein the adhesive layer comprises at least one of a pressure sensitive adhesive, a thermally activated adhesive, a hot melt adhesive, a radiation cured adhesive, or combinations thereof.

Embodiment 30. The multilayer card of any one of embodiments 21 to 29, wherein the asymmetrically stretched polymer core layer has a thickness in a range from about 50 micrometers to about 510 micrometers.

Embodiment 31. The multilayer card of any one of embodiments 21 to 30, wherein the multilayer card passes a CARD WARPAGE TEST as measured according to ISO/IEC 10373-1:2006(E) and ISO/IEC 7810:2003(E).

Embodiment 32. A composite article comprising:
an asymmetrically stretched polyester layer;
an ink-receptive layer disposed on a first major surface of the asymmetrically stretched polyester layer; and
an adhesive layer disposed on a second major surface of the asymmetrically stretched polyester layer;
wherein the asymmetrically stretched polyester core layer is stretched in a first direction by a first stretch of 1.02 to 2.0 times an unstretched first dimension and stretched in a second direction perpendicular to the first direction by a second amount of 3.0 to 7.0 times an unstretched second dimension.

Embodiment 33. The composite article of embodiment 32, wherein the asymmetrically stretched polyester layer comprises semi-crystalline polyethylene terephthalate.

Embodiment 34. The composite article of embodiment 32 or embodiment 33, wherein the asymmetrically stretched polyester layer has a thickness in a range from about 50 micrometers to about 510 micrometers.

Embodiment 35. The composite article of any one of embodiments 32 to 34, wherein the ink-receptive layer comprises a polymeric material selected from the group consisting of polyethylene terephthalate, polyethylene naphthalate, polyvinyl chloride, polycarbonate, polyurethane, polyacrylate, copolymers thereof, and blends thereof.

Embodiment 36. The composite article of any one of embodiments 32 to 35, wherein the adhesive layer comprises at least one of a pressure sensitive adhesive, a thermally activated adhesive, a hot melt adhesive, a radiation cured adhesive, or combinations thereof in the form of either blends or copolymers.

Embodiment 37. The composite article of any one of embodiments 32 to 36, wherein a ratio of the second stretch to the first stretch is in a range from about 1.5 to about 7.

Embodiment 38. A method of making a multilayer card, the method comprising:
forming a web from a polyester material;
stretching the web in a first direction by a first stretch amount;
stretching the web in a second direction perpendicular to the first direction by a second stretch amount, wherein a ratio of the second stretch to the first stretch is in a range from about 1.5 to about 7.0;
converting the web into a plurality of asymmetrically stretched polyester sheets;
randomly selecting a first asymmetrically stretched polyester sheet and a second asymmetrically stretched polyester sheet from the plurality of asymmetrically stretched polyester sheets;
forming a multilayer stack comprising a core support layer, first and second cover layers disposed on opposite major surfaces of the multilayer stack, the first asymmetrically stretched polyester sheet disposed between the core support layer and first cover layer, and the second asymmetrically stretched polyester sheet disposed between the core support layer and the second cover layer; wherein the first and second asymmetrically stretched polyester sheets are aligned with respect to the first direction;
laminating the multilayer stack to form a laminated multilayer stack; and
converting a portion of the laminated multilayer stack to a multilayer card.

Embodiment 39. A multilayer card comprising:
first and second cover layers disposed on opposite major surfaces of the multilayer card;
a core support layer disposed between the first and second cover layers;
a first asymmetrically stretched polyester layer disposed between the first cover layer and the core support layer;
a second asymmetrically stretched polyester layer disposed between the second cover layer and the core support layer;
a first ink-receptive layer disposed between the first cover layer and the first asymmetrically stretched polyester layer;
a second ink-receptive layer disposed between the second cover layer and the second asymmetrically stretched polyester layer;
a first adhesive layer disposed between the first asymmetrically stretched polyester layer and the core support layer; and
a second adhesive layer disposed between the second asymmetrically stretched polyester layer and the core support layer;
wherein the first and second asymmetrically stretched polyester layers are each stretched in a first direction by a first stretch amount and stretched in a second direction perpendicular to the first direction by a second amount, wherein a ratio of the second stretch to the first stretch is in a range from about 1.5 to about 7.0, and wherein the first and second stretched layers are aligned with respect to the first direction.

Embodiment 40. The method of embodiment 1, wherein the polyester material is selected from the group consisting of polyethylene terephthalate, polyethylene naphthalate, polybutylene terephthalate, copolymers thereof, and blends thereof.

### EXAMPLES

The present disclosure is more particularly described in the following examples that are intended as illustrations only, since numerous modifications and variations within the scope of the present disclosure will be apparent to those skilled in the art. All parts, percentages, ratios, etc. in the examples are by weight, unless noted otherwise noted.

### Card Warpage Test Method

A “CARD WARPAGE TEST” was performed on multilayer cards to assess card warpage according to ISO/IEC 10373-1:2006(E), Section 5.1 “Card warpage”, and the card warpage test results were evaluated according to ISO/IEC 7810:2003(E), Section 8.11 “Overall card warpage”. Multilayer cards having a card warpage value within the specifications of the CARD WARPAGE TEST METHOD were listed as having “Results In-Spec”.

### Materials

| Abbreviation/product | | |
|---|---|---|
| name | Description | Available from |
| ELVALOY 2618 | Hot tack adhesive resin | DuPont, Wilmington, DE |
| INVISTA 8426A PET | Polyethylene terephthalate resin | Invista, Wichita, KS |
| INVISTA 8602 PET | Polyethylene terephthalate resin | Invista, Wichita, KS |
| PET 339 | White polyethylene terephthalate film | Mitsubishi Chemical, |
| | with a thickness of about 127 | Tokyo, Japan |
| | micrometers (5 mils) that has been | |
| | biaxially stretched at a draw rate of about | |
| | 3.5 × 3.5. The polyethylene terephthalate | |
| | film as supplied had an ink-receptive | |
| | primer on each side. | |
| RHOPLEX 3208 | Ink-receptive primer layer | Dow Chemical, Midland, MI |
| PENTAPLAST SB6 | 2 mil (51 micrometer) polyvinyl chloride | Klöckner Pentaplast of |
| | adhesive overlay film | America, Inc., |
| | | Gordonsville, VA |
| PENTAPLAST RIGID | 10 mil (250 micrometer) polyvinyl | Klöckner Pentaplast of |
| PVC FILM | chloride support film | America, Inc., |
| | | Gordonsville, VA |
| TRANSILWRAP 1/1/1 | Hot melt adhesive film | Transilwrap Co., Franklin |
| | | Park, IL |

### Comparative Example C1

An adhesive layer was coated via an extrusion coating process on one side of PET 339 film using an ELVALOY 2618 hot tack adhesive resin at a thickness of about 25 micrometers (1 mil). A single screw extruder was used during the extrusion coating process. The melt train temperature was between 204° C. and 249° C. (400° F. and 480° F.) and the line speed was 7.6 m/min (25 ft/min).

The resulting film was cut into 30 cm by 30 cm sheets using a sheet cutter. Two sheets were randomly selected from the same general position in the transverse direction of the film (i.e., the conventional lane registration approach was not followed). The two PET sheets were placed on opposite sides of a 0.25 mm (10 mils) PENTAPLAST RIGID PVC FILM with the adhesive side of the PET facing the support film, and 50 micrometer (2 mils) PENTAPLAST SB6 overlay films were placed immediately adjacent to each PET film opposite the support film (with the adhesive side of the overlay film facing the center of the multilayer stack). The lamination was performed under a pressure of about 1 MPa (150 psi) and a temperature of about 149° C. (300° F.) for about 15 minutes. The overall thickness of resulting laminate was about 0.76 mm (30 mils).

The laminate was converted into credit card shape to make 10 comparative example cards that were tested according to the CARD WARPAGE TEST METHOD. Each of the comparative example cards tested had out-of-specification warpage according to the CARD WARPAGE TEST METHOD specifications.

### Examples 1-10

A film was made by extruding INVISTA 8426A PET resin using a twin screw extruder through a film-forming die and casting onto a water-cooled, rotating quenching drum. The melt temperature was in the range of about 249° C.-288° C. (480° F. to 550° F.) and the drum temperature was in the range of about 21° C. to 38° C. (70° F. to 100° F.). The initial film thickness after extruding and casting was about 0.63 mm to 0.76 mm (25 mils to 30 mils). After extruding and casting, the film was stretched on a tenter machine in the machine direction (MD) at a nominal draw ratio of 1.15, where the stretching temperature was in the range of 90° C. to 105° C. Based on previous calibrations of the tenter machine, the actual resulting MD draw ratio was in the range of 1.02 to 1.2. The resulting film was then coated via a pretenter coating process with a RHOPLEX 3208 ink-receptive primer layer and then subsequently the film was stretched in the transverse direction (TD) at a nominal draw ratio of 4.5, where the stretching temperature was again in the range of 90° C.-105° C. Based on previous calibrations of the tenter machine, the actual resulting TD draw ratio was in the range of 4.0 to 5.0. After stretching, the film was then heat relaxed under low tension at temperatures in the range of 140° C.-180° C. The resulting asymmetrically stretched film was about 112 inches (284 cm) wide, and was slit into 2 rolls of equal width, i.e., about 56 inches (142 cm). The film was then cut again along the machine direction into 4 lanes of approximately equal width, i.e., about 14 inches (about 36 cm) using a slitter, and the 4 lanes were labeled A, B, C and D for subsequent processing.

An adhesive layer was then coated along the machine direction via an extrusion coating process on one side of the 4 lanes of asymmetrically stretched PET films (i.e., on the side opposite the ink-receptive primer layer), using ELVALOY 2618 hot tack adhesive resin at thickness of about 25 micrometers (1 mil). A single screw extruder was used during the extrusion coating process. The melt train temperature was between about 204° C. and 249° C. (400° F. and 480° F.) and the line speed was about 7.6 m/min (25 ft/min). The resulting asymmetrically stretched PET films having an adhesive on one side and the ink-receptive primer layer on the opposite side were then cut along the transverse direction into 30 cm by 30 cm (12 inch by 12 inch) asymmetrically stretched sheets using a sheet cutter. The conventional lane registration approach was not followed and two asymmetrically stretched sheets were selected to obtain any combination of sheets from Lanes A, B, C, and D. The two asymmetrically stretched sheets were placed on opposite sides of a 0.25 mm (10 mils) PENTAPLAST RIGID PVC FILM with the adhesive side of the asymmetrically stretched sheets facing the support film, and 50 micrometer (2 mils) PENTAPLAST SB6 overlay films were placed immediately adjacent to the ink-receptive primer layer on each of the asymmetrically stretched sheets, to form a multilayer stack, and the multilayer stack was then laminated using the same conditions as described for Comparative Example C1. The overall laminate thickness was about 0.76 mm (30 mils).

Each laminate was then converted into credit card shape and tested according to CARD WARPAGE TEST METHOD. At least six cards were made for each of Examples 1 to 10. The resulting cards (i.e., each sample for Examples 1-10) all had card warpage test results that were within the specifications (“In-Spec”) according to the CARD WARPAGE TEST METHOD, as indicated in the Table 1 below.

TABLE 1

| | | | | CARD |
|---|---|---|---|---|
| | | | | WARPAGE |
| | Lane | MD | TD | TEST METHOD |
| Examples | Registration | Stretch | Stretch | Result In-Spec? |
| Comparative | A/A | 3.5 | 3.5 | No |
| Example C1 | | | | |
| Example 1 | A/A | 1.02 to 1.2 | 4.0 to 5.0 | Yes |
| Example 2 | A/B | 1.02 to 1.2 | 4.0 to 5.0 | Yes |
| Example 3 | A/C | 1.02 to 1.2 | 4.0 to 5.0 | Yes |
| Example 4 | A/D | 1.02 to 1.2 | 4.0 to 5.0 | Yes |
| Example 5 | B/B | 1.02 to 1.2 | 4.0 to 5.0 | Yes |
| Example 6 | B/C | 1.02 to 1.2 | 4.0 to 5.0 | Yes |
| Example 7 | B/D | 1.02 to 1.2 | 4.0 to 5.0 | Yes |
| Example 8 | C/C | 1.02 to 1.2 | 4.0 to 5.0 | Yes |
| Example 9 | C/D | 1.02 to 1.2 | 4.0 to 5.0 | Yes |
| Example 10 | D/D | 1.02 to 1.2 | 4.0 to 5.0 | Yes |
| Example 11 | A/A | 1.8 to 2.0 | 5.5 to 6.5 | Yes |

As shown in Table 1, Comparative Example C1 having sheets from the same lane (A/A) resulted in a card having card warpage that was not in-spec, whereas Examples 1 to 10 demonstrated that a sheet from any lane paired with another sheet from any lane resulted in cards that were in-spec.

### Example 11

A film was made by extruding a PET resin (INVISTA 8602) using a twin screw extruder through a film-forming die and casting onto a water-cooled, rotating quenching drum. The melt temperature was in the range of about 249° C. to 288° C. (480° F. to 550° F.) and the drum temperature was in the range of about 21° C. to 38° C. (70° F. to 100° F.). The initial film thickness after extruding and casting was about 100 mils (2.5 mm) After extruding and casting, the film was stretched in the machine direction at a nominal draw ratio of 1.9 with the stretching temperature was in the range of 95° C. to 110° C. Based on previous calibrations of the tenter machine, the actual resulting MD draw ratio was in the range of 1.8 to 2.0. The film was then stretched in the transverse direction at a nominal draw ratio of 6.1, where the stretching temperature was again in the range of 95° C. to 110° C. Based on previous calibrations of the tenter machine, the actual resulting TD draw ratio was in the range of 5.5 to 6.5 After stretching, the film was then heat relaxed under low tension at temperatures in the range of 200° C. to 230° C. The resulting film had a thickness of about 8-9 mils (203 micrometers to 229 micrometers). The film was then cut along the machine direction into 4 lanes of approximately equal width using a table cutter (labeled Lanes A, B, C and D) for subsequent processing. Lane A was further cut using a table cutter into 12 inch by 12 inch (30 cm by 30 cm) sheets along the transverse direction.

The conventional lane registration approach was not followed. Instead, two sheets were picked only from Lane A and were laminated using the same multilayer stack construction and lamination conditions as described for Comparative Example 1, using the asymmetrically stretched PET film sheets in place of the PET 339 film. A layer of hot melt adhesive film (TRANSILWRAP 1/1/1) was also used in place of the extrusion coated adhesive to laminate the asymmetrically stretched PET film sheets to the center PENTAPLAST RIGID PVC FILM core film. The overall laminate thickness was about 34 mils (0.86 mm).

The laminate was converted into credit card shapes to make six example cards that were tested according to the CARD WARPAGE TEST METHOD. The resulting cards (Example 11) were within specifications of the CARD WARPAGE TEST METHOD, as was listed in the Table 1 immediately above.

### Comparative Example C2

A PET film was made by extruding a PET resin (INVISTA 8602) using a twin screw extruder through a film-forming die and casting onto a water-cooled, rotating quenching drum. The melt temperature was in the range of about 249° C. to 288° C. (480° F. to 550° F.) and the drum temperature was in the range of about 21° C. to 38° C. (70° F. to 100° F.). The initial film thickness after extruding and casting was about 100 mils (2.5 mm) After extruding and casting, the film was stretched in the machine direction at a nominal draw of 2.4, with the stretching temperature in the range of 95° C. to 110° C. Based on previous calibrations of the tenter machine, the actual resulting MD draw ratio was in the range of 2.3 to 2.5. The film was then stretched in the transverse direction at a nominal draw ratio of 6.1, where the stretching temperature was again in the range of 95° C. to 110° C. Based on previous calibrations of the tenter machine, the actual resulting TD draw ratio was in the range of 5.5-6.5 After stretching, the film was then heat relaxed under low tension at temperatures in the range of 200° C. to 230° C. The resulting film was not flat enough to be useful for card applications. No further processing was done.

1. A multilayer card comprising:
first and second cover layers disposed on opposite major surfaces of the multilayer card;
a core support layer disposed between the first and second cover layers;
a first asymmetrically stretched polyester layer disposed between the first cover layer and the core support layer;
a second asymmetrically stretched polyester layer disposed between the second cover layer and the core support layer;
a first ink-receptive layer disposed between the first cover layer and the first asymmetrically stretched polyester layer;
a second ink-receptive layer disposed between the second cover layer and the second asymmetrically stretched polyester layer;
a first adhesive layer disposed between the first asymmetrically stretched polyester layer and the core support layer; and
a second adhesive layer disposed between the second asymmetrically stretched polyester layer and the core support layer;
wherein the first and second asymmetrically stretched polyester layers are each stretched in a first direction by a first stretch of 1.02 to 2.0 times an unstretched first dimension and stretched in a second direction perpendicular to the first direction by a second amount of 3.0 to 7.0 times an unstretched second dimension, and wherein the first and second asymmetrically stretched polyester layers are aligned with respect to the first direction.

2. A multilayer card comprising:
first and second cover layers disposed on opposite major surfaces of the multilayer card;
an asymmetrically stretched polyester core layer disposed between the first and second cover layers;
a first ink-receptive layer disposed between the first cover layer and the asymmetrically stretched polyester core layer;
a second ink-receptive layer disposed between the second cover layer and the asymmetrically stretched polyester core layer;
a first adhesive layer disposed between the first ink-receptive layer and the asymmetrically stretched polyester core layer; and
a second adhesive layer disposed between the second ink-receptive layer and the asymmetrically stretched polyester core layer;
wherein the asymmetrically stretched polyester core layer is stretched in a first direction by a first stretch of 1.02 to 2.0 times an unstretched first dimension and stretched in a second direction perpendicular to the first direction by a second amount of 3.0 to 7.0 times an unstretched second dimension.

3. A composite article comprising:
an asymmetrically stretched polyester layer;
an ink-receptive layer disposed on a first major surface of the asymmetrically stretched polyester layer; and
an adhesive layer disposed on a second major surface of the asymmetrically stretched polyester layer;
wherein the asymmetrically stretched polyester core layer is stretched in a first direction by a first stretch of 1.02 to 2.0 times an unstretched first dimension and stretched in a second direction perpendicular to the first direction by a second amount of 3.0 to 7.0 times an unstretched second dimension.

4. The multilayer card of claim 1, wherein the polyester in the asymmetrically stretched polyester layers is semi-crystalline polyethylene terephthalate.

5. The multilayer card of claim 1, wherein the first and second cover layers each comprise a polymeric material selected from the group consisting of polyethylene terephthalate, polyethylene naphthalate, polyvinyl chloride, polycarbonate, poly(methyl methacrylate), copolymers thereof, and blends thereof, and has a thickness in a range from about 25 micrometers to about 250 micrometers.

6. The multilayer card of claim 1, wherein the ink-receptive layers each comprise a polymeric material selected from the group consisting of polyethylene terephthalate, polyethylene naphthalate, polyvinyl chloride, polycarbonate, polyurethane, polyacrylate, copolymers thereof, and blends thereof.

7. The multilayer card of claim 1, wherein a ratio of the second stretch to the first stretch is in a range from 1.5 to 7.

8. The multilayer card of claim 1, wherein the asymmetrically stretched polyester layers are opaque.

9. The multilayer card of claim 1, wherein the asymmetrically stretched polyester layers further comprises at least one of a UV absorber, a color pigment, a plasticizer, and anti-plasticizer, or a combination thereof.

10. The multilayer card of claim 1, wherein the multilayer card passes a CARD WARPAGE TEST as measured according to ISO/IEC 10373-1:2006(E) and ISO/IEC 7810:2003(E).
